(19) United States
(12) Patent Application Publication
(10) Pub. No.: US 2026/0279660 A1
(43) Pub. Date: Sep. 17, 2026

(54) BATTERY-OPTIMIZED COMPENSATION SYSTEM

(71) Applicant: BLUEWIND MEDICAL LTD., Herzlia (IL)

(72) Inventors: Gur ORON, Tel Aviv (IL); Eran BENJAMIN, Tel Aviv (IL); Alexander FIRTEL, Ashdod (IL); Amiel GREENBERG, Rehovot (IL); Yigal ELISHA, Tel Aviv (IL)

(73) Assignee: BLUEWIND MEDICAL LTD., Herzlia (IL)

(21) Appl. No.: 19/678,974

(22) Filed: May 15, 2026

Related U.S. Application Data
(63) Continuation of application No. 18/058,184, filed on Nov. 22, 2022, now Pat. No. 12,646,652.
(60) Provisional application No. 63/282,758, filed on Nov. 24, 2021.

(51) Int. Cl. H01F 38/14; H04B 5/79

(52) U.S. Cl. CPC H01F 38/14; H04B 5/79

(57) ABSTRACT

A housing placeable against skin of a subject includes a transmitting coil. Battery-powered control circuitry including a power stage transmits power to an implant by activating the power stage to drive a current through the transmitting coil to induce an induced current in a receiving coil of the implant. A sensor indicates divergence of a real-time resonance frequency of the transmitting coil with respect to a reference resonance frequency of the transmitting coil at which (a) efficiency of the power stage is at least 70% of a maximum efficiency as a function of the resonance frequency, and (b) the current driven through the transmitting coil is less than 96% of a maximum current drivable through the transmitting coil as a function of the resonance frequency. The circuitry reduces the divergence by tuning the resonance frequency of the transmitting coil. Other applications are also described.

### CROSS REFERENCE TO RELATED APPLICATION

The present application claims the priority of U.S. 63/282,758 to Oron, filed Nov. 24, 2021, entitled, “Battery compensation system using RF power amplifier,” which is incorporated herein by reference.

### FIELD OF THE INVENTION

Applications of the present invention relate to transmitting power to an implanted medical device.

### BACKGROUND

Electrical power can be transferred to a medical implant by magnetic induction. A current flowing through a coil produces a magnetic field, which, in turn, will induce a current in a second coil. A coil inside a medical implant can therefore act as a receiving coil, while a coil outside a patient's body can act as a transmitting coil. A current can be driven through the transmitting coil in order to induce an induced current in the receiving coil, thereby powering the medical implant.

U.S. Pat. No. 11,213,685 to Oron et al. which is incorporated herein by reference, describes apparatus for use with a medical implant having a receiving coil. A flexible housing to be placed against skin of a subject includes a flexible transmitting coil and control circuitry for driving a current through the transmitting coil to induce a current in the receiving coil. A sensor coupled to the circuitry determines divergence of a resonance frequency of the transmitting coil when flexed from a nominal resonance frequency of the transmitting coil, occurring in the absence of any forces applied to the transmitting coil. One or more electrical components coupled to the circuitry tune the resonance frequency of the transmitting coil. A switch is coupled to each of the electrical components, the switches including transistors having capacitances that depend on the voltage applied to each switch. The circuitry applies a voltage of 30-300 volts to each switch. Other applications are also described.

U.S. Pat. No. 7,015,769 to Schulman describes an automatic tuning system for a magnetic field generating tuned circuit including a processor configured to maintain the resonant frequency of a tuned circuit equal to a reference frequency. The tuned circuit is driven by a power amplifier whose output provides an amplified signal at the reference frequency. The tuned circuit includes a magnetic field generating inductor and a bank of individually switchable capacitors controlled by the processor capable of adding and removing the respective capacitances to and from the tuned circuit. The inductor includes a Faraday shield to shield the tuned circuit from the influence of electric fields. A power sense circuit monitors the power delivered by the power amplifier to the tuned circuit and the processor sequentially switches the capacitors in a binary progression format to achieve maximum power delivery indicative of conforming the resonant frequency of the tuned circuit to the reference frequency. In an alternate embodiment of the invention, the inductor includes a plurality of taps that provide individually selectable inductance values available for use in the process of conforming the resonant frequency of the tuned circuit to the reference frequency. In further alternate embodiments, the variable capacitor is in the form of a motor driven variable capacitor and the tuning sequence relies on a phase locked loop using the phase of a reference frequency signal and the phase of the inductor current as control parameters.

U.S. Pat. No. 9,220,908 to Mashiach describes a sleep apnea treatment device which may include a flexible carrier configured to be implanted in a body of a subject. The device may also include at least one electrode disposed on the flexible carrier, the at least one electrode being configured to modulate nerve fibers of the subject. A flexible antenna may be disposed on the flexible carrier, the flexible antenna electrically connected to the at least one electrode in a manner permitting at least some energy received by the flexible antenna to be transferred to the at least one electrode. The flexible antenna may include: at least a first conductive trace arranged on a first side of the flexible carrier, the at least a first conductive trace defining at least a first elongated space between portions thereof; and at least a second conductive trace arranged on a second side of the flexible carrier, the at least a second conductive trace defining at least a second elongated space between portions thereof, wherein the at least a first conductive trace is at least partially offset from the at least a second conductive trace such that portions of the first conductive trace overly the at least a second elongated space and wherein portions of the second conductive trace underlay the at least a first elongated space.

### SUMMARY OF THE INVENTION

In accordance with some applications of the present invention, a transmitting coil is disposed within a housing that is configured to be placed against skin of a subject in order to transmit power to a medical implant. To transmit the power to the medical implant, battery-powered control circuitry activates a power stage, e.g., a power amplifier, to drive a current through the transmitting coil to induce an induced current in a receiving coil of the medical implant. Variations in the impedance of the transmitting coil cause variations in the resonance frequency of the transmitting coil, causing the transmitting coil to act as a variable load for the power stage. The load variation is assumed to occur mostly as variation in the reactance of the transmitting coil (e.g., changes in the inductance and/or capacitance of the transmitting coil), while the resistance of the transmitting coil is almost constant. Changes in inductance and/or capacitance of the transmitting coil may occur, for example, due to the transmitting coil flexing, due to changes in temperature of the transmitting coil, or due to the transmitting coil being in close proximity to metal in the environment of the patient.

As the power stage load varies, i.e., as the resonance frequency of the transmitting coil varies, the resistance of the power supplied to the power stage, i.e., the input resistance to the power stage, varies, which causes the input current to the power stage to vary (since the input voltage to the power stage is kept almost constant). If variations in the resonance frequency of the transmitting coil cause the input resistance of the power stage to drop, this may result in a high input current to the power stage. Since the control circuitry is battery-operated, a high input current to the power stage, i.e., a high current demand on the battery, may cause rapid depletion of the battery and/or may cause the battery to disconnect if the current demand on the battery surpasses a battery overcurrent protection limit for the battery.

For some applications, when transmitting power to a medical implant, the driving frequency of the transmitting coil is held constant at a fixed frequency, or within a set frequency band. However, variations that occur in the inductance and/or capacitance of the transmitting coil cause a variation in the resonance frequency of the transmitting coil. This in turn causes variations in the system response to the driving frequency as a function of the resonance frequency of the transmitting coil. For example, the RF current at the output of the power stage (i.e., the current driven through the transmitting coil), the input resistance of the power stage, and the efficiency of the power stage all vary as functions of the resonance frequency of the transmitting coil. Thus, a compensation circuit, such as described in the above-referenced U.S. Pat. No. 11,213,685 to Oron et al. may be used for real-time tuning of the transmitting coil in order to frequency of the compensate for changes in the resonance transmitting coil. The control circuitry typically receives input from a sensor and if the sensor determines an indication of divergence of a real-time resonance frequency of the transmitting coil with respect to a reference resonance frequency of the transmitting coil, then the control circuitry utilizes one or more electrical components coupled to the control circuitry to reduce the divergence by tuning the resonance frequency of the transmitting coil.

As noted hereinabove, U.S. Pat. No. 7,015,769 to Schulman describes a power sense circuit that monitors the power delivered by a power amplifier to a tuned circuit and a processor that sequentially switches the capacitors in a binary progression format to achieve maximum power delivery indicative of conforming the resonant frequency of the tuned circuit to the reference frequency. However, the inventors of the present application have realized that when using battery-powered circuitry to drive the transmitting coil, maximizing the current driven through the transmitting coil results in a high current demand on the battery. As such, the inventors have realized that for a battery-powered system, it is advantageous to optimize efficiency of the power stage rather than to optimize the power transmitted to the medical implant. Efficiency of the power stage is defined as power output by the power stage divided by power input to the power stage.

Thus, the inventors have realized that it is advantageous to a battery-operated power transmission system to set the reference resonance frequency of the transmitting coil (from which divergences of the real-time resonance frequency are reduced) such that both of the following two conditions are met at the reference resonance frequency of the transmitting coil:
(a) efficiency of the power stage is at least 70% of a maximum efficiency of the power stage as a function of the resonance frequency of the transmitting coil, and
(b) the current driven through the transmitting coil is less than 96% of a maximum current drivable through the transmitting coil as a function of the resonance frequency of the transmitting coil.

(Thus, if for example the maximum efficiency of the power stage as a function of the resonance frequency of the transmitting coil is 80%, then the efficiency of the power stage being at least 70% of the maximum efficiency of the power stage as a function of the resonance frequency means that the efficiency of the power stage is at least 70%*80%=56%.)

In the present application, various parameters (such as the efficiency of the power stage and the current drivable through the transmitting coil) are described as varying as a function of the resonance frequency of the transmitting coil. This is to be understood as relating to the resonance frequency varying while the output voltage of the power stage is held constant.

The inventors have realized that when the power stage is operating near its maximum efficiency (i) the efficiency of the power stage varies slowly with changes in the resonance frequency of the transmitting coil while (ii) the input resistance of the power stage varies quickly with changes in the resonance frequency of the transmitting coil. As such, even at maximum efficiency of the power stage, a variation in resonance frequency of the transmitting coil may cause the input resistance of the power stage to quickly decrease or increase, which in turn may cause the input current to the power stage to increase or decrease, respectively. Thus, in this regard, the inventors have realized that it is advantageous to a battery-operated power transmission system to set the reference resonance frequency of the transmitting coil (from which divergences of the real-time resonance frequency are reduced) such that both of the following two conditions are met at the reference resonance frequency of the transmitting coil:
(a) efficiency of the power stage is less than 95% (while nevertheless at least 70%) of a maximum efficiency of the power stage as a function of the resonance frequency of the transmitting coil, and
(b) the current driven through the transmitting coil is less than 96% of a maximum current drivable through the transmitting coil as a function of the resonance frequency of the transmitting coil.

There is therefore provided, in accordance with some applications of the present invention, apparatus for use with a medical implant that comprises a receiving coil, the apparatus including:
a housing configured to be placed against skin of a subject;
a transmitting coil disposed in the housing;
control circuitry including a power stage and configured to transmit power to the medical implant by activating the power stage to drive a current through the transmitting coil to induce an induced current in the receiving coil;
a battery coupled to the housing and configured to power the control circuitry;
a sensor configured to determine an indication of divergence of
   (i) a real-time resonance frequency of the transmitting coil, with respect to
   (ii) a reference resonance frequency of the transmitting coil at which:
      (a) efficiency of the power stage is at least 70% of a maximum efficiency of the power stage as a function of the resonance frequency of the transmitting coil, the efficiency of the power stage defined as power output by the power stage divided by power input to the power stage, and
      (b) the current driven through the transmitting coil is less than 96% of a maximum current drivable through the transmitting coil as a function of the resonance frequency of the transmitting coil; and
one or more electrical components, coupled to the control circuitry,
   wherein the control circuitry is configured to receive an input from the sensor indicative of the divergence and use the one or more electrical components to reduce the divergence by tuning the resonance frequency of the transmitting coil in response to the determination of the sensor.

For some applications, the housing is a flexible housing.

For some applications, the transmitting coil is a flexible transmitting coil and the real-time resonance frequency is a flexed resonance frequency when the transmitting coil is flexed.

For some applications, the control circuitry is configured to transmit power to the medical implant by activating the power stage to drive the current at a fixed frequency through the transmitting coil to induce the induced current in the receiving coil.

For some applications, the control circuitry is configured to transmit power to the medical implant by activating the power stage to drive the current at a fixed frequency of 6.78 MHz through the transmitting coil to induce the induced current in the receiving coil.

For some applications, the control circuitry is configured to transmit power to the medical implant by activating the power stage to drive the current within a set frequency band through the transmitting coil to induce the induced current in the receiving coil.

For some applications, the control circuitry is configured to transmit power to the medical implant by activating the power stage to drive the current within the set frequency band, wherein the set frequency band is a range of frequencies that includes 6.78 MHz within the range.

For some applications, the control circuitry is configured such that the reference resonance frequency of the transmitting coil is lower than a resonance frequency of the transmitting coil at which the efficiency of the power stage is the maximum efficiency.

For some applications, the control circuitry is configured such that the reference resonance frequency of the transmitting coil is a resonance frequency of the transmitting coil at which the efficiency of the power stage is less than 95% of the maximum efficiency.

For some applications, the control circuitry is configured such that the reference resonance frequency of the transmitting coil is a resonance frequency of the transmitting coil at which the efficiency of the power stage is at least 75% of the maximum efficiency.

The present invention will be more fully understood from the following detailed description of applications thereof, taken together with the drawings, in which:

### BRIEF DESCRIPTION OF THE DRAWINGS

FIG. 1A is a block diagram of control circuitry used to drive a transmitting coil to power a medical implant, in accordance with some applications of the present invention;

FIG. 1B is a schematic illustration of a housing placed against skin of a subject, and a medical implant implanted under the skin of the subject, in accordance with some applications of the present invention; and

FIGS. 2-4 show graphs depicting, respectively, RF current at the output of a power stage of the control circuitry, the input resistance of the power stage, and the efficiency of the power stage, all plotted as functions of resonance frequency of the transmitting coil.

### DETAILED DESCRIPTION

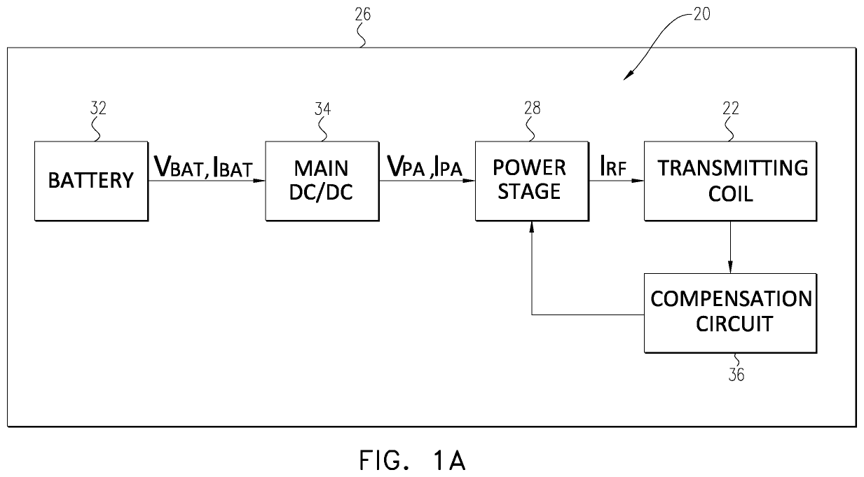

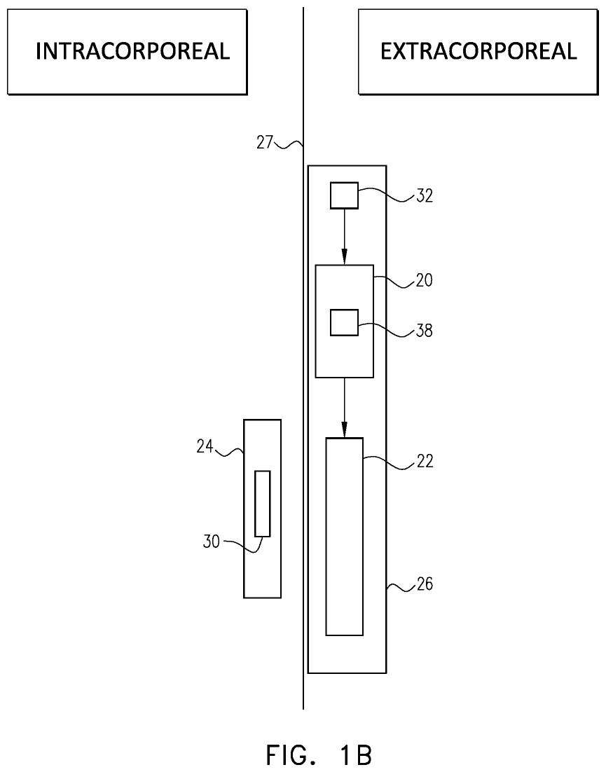

Reference is now made to FIG. 1A, which is a block diagram of control circuitry 20 used to drive a transmitting coil 22 to power a medical implant 24 (shown in FIG. 1B), in accordance with some applications of the present invention. Transmitting coil 22 is disposed within a housing 26 that is configured to be placed against skin 27 of a subject. Control circuitry 20 includes a power stage 28, e.g., a power amplifier (“PA” in the figures), and transmits power to medical implant 24 by activating power stage 28 to drive a current through transmitting coil 22 to induce an induced current in a receiving coil 30 of medical implant 24. A battery 32 is coupled to housing 26 and configured to power control circuitry 20. For some applications the current (I_{BAT}) from battery 32 goes through a DC/DC converter 34 before entering power stage 28. As further described hereinbelow, a compensation circuit 36 (e.g., comprising switchable capacitors and/or inductors), such as described in the above-referenced U.S. Pat. No. 11,213,685 to Oron et al., may be used for real-time tuning of transmitting coil 22 in order to compensate for changes in the resonance frequency of transmitting coil 22. Control circuitry 20 typically receives input from a sensor 38 (FIG. 1B) that is configured to determine an indication of divergence of (i) a real-time resonance frequency of transmitting coil 22, with respect to (ii) a reference resonance frequency of transmitting coil 22, further described hereinbelow. If a divergence is indicated, then control circuitry 20 utilizes one or more electrical components coupled to control circuitry 20 to reduce the divergence by tuning the resonance frequency of transmitting coil 22 in response to the determination of sensor 38. For example, techniques described with reference to FIGS. 8-14 in the above-referenced U.S. Pat. No. 11,213,685 may be utilized in combination with the apparatus described herein to tune the resonance frequency of transmitting coil 22.

Reference is now made to FIG. 1B, which is a schematic illustration of housing 26 placed against skin 27 of a subject, and medical implant 24 implanted under skin 27 of the subject, in accordance with some applications of the present invention. Battery 32 is coupled to the housing and powers control circuitry 20. Control circuitry 20 and transmitting coil 22 are shown disposed within housing 26. Medical implant 24 including receiving coil 30 is shown to be implanted in the subject in contact with tissue of the subject.

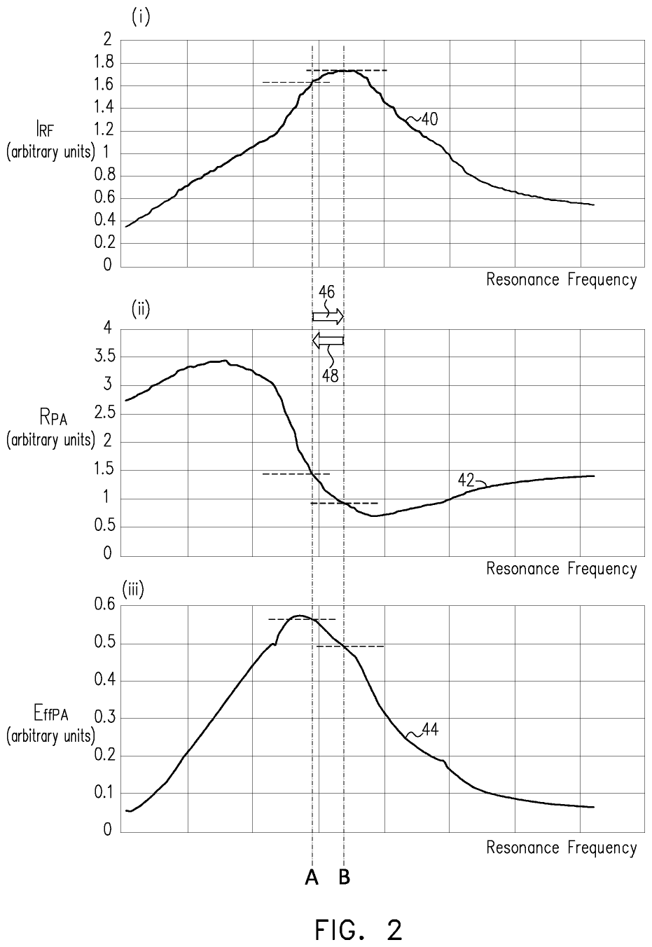

Reference is now made to FIG. 2, which shows graphs (i), (ii), and (iii) depicting, respectively, the RF current (I_{RF}) at the output of power stage 28, the input resistance (R_{PA}) of power stage 28, and the efficiency of power stage 28, when operated at a set fixed frequency, all plotted as functions of the resonance frequency of transmitting coil 22, in accordance with some applications of the present invention. As described hereinabove, variations in impedance of transmitting coil 22 cause variations in the resonance frequency of transmitting coil 22, causing transmitting coil 22 to act as a variable load for power stage 28.

For some applications, control circuitry 20 transmits power to medical implant 24 by activating power stage 28 to drive the current at a fixed frequency (e.g., 6.78 MHz), or within a set frequency band (e.g., 6.765-6.795 MHz), through transmitting coil 22 to induce the induced current in receiving coil 30. Each vertical line in FIG. 2 spanning graphs (i), (ii), and (iii) represents a specific resonance frequency of transmitting coil 22. The intersections of each vertical line with the respective curves 40, 42, and 44 of graphs (i), (ii), and (iii) indicate, respectively, the RF current (I_{RF}) at the output of power stage 28 (i.e., the current driven through transmitting coil 22), the input resistance (R_{PA}) of power stage 28, and the efficiency of power stage 28 at the specific resonance frequency of transmitting coil 22 represented by the vertical line.

For some applications for a given power transmission system, a reference resonance frequency of transmitting coil 22 is set such that one or more parameters of the system are optimized (further described hereinbelow) when transmitting coil 22 is at the reference resonance frequency, i.e., a reference resonance frequency is set at which transmitting coil 22 should ideally be maintained. However, for some applications, changes may occur in the inductance and/or capacitance of transmitting coil 22 (e.g., due to flexing of transmitting coil 22) during operation of transmitting coil 22, causing a real-time resonance frequency of transmitting coil 22 to vary and thus diverge from the reference resonance frequency of transmitting coil 22.

For example, if the reference resonance frequency of transmitting coil 22 is set to be at vertical line A in FIG. 2 (selected in FIG. 2 for illustrative purposes to be somewhat to the left of the peak of curve 40), a change in inductance and/or capacitance of transmitting coil 22 may cause the real-time resonance frequency of transmitting coil 22 to diverge from vertical line A, such that the real-time resonance frequency of transmitting coil 22 is at vertical line B. This divergence is illustrated by arrow 46 in FIG. 2. As shown by the intersections of vertical lines A and B with curves 40, 42, and 44, the divergence of the real-time resonance frequency of transmitting coil 22 causes (a) the magnitude of the power transmission to medical implant 24 to change due to the change in RF current (I_{RF}) driven through transmitting coil 22, (b) the amount of current (I_{BAT}) being drawn from battery 32 to change due to the change in the input resistance (R_{PA}) of power stage 28, and (c) the efficiency of power stage 28 to change. Thus, given the particular locations of vertical lines A and B, the divergence of the real-time resonance frequency of transmitting coil 22 causes (a) the magnitude of the power transmission to medical implant 24 to increase, (b) the amount of current (I_{BAT}) being drawn from battery 32 to increase, and (c) the efficiency of power stage 28 to decrease.

Compensation circuit 36 is used for real-time tuning of transmitting coil 22 in order to compensate for these changes in the resonance frequency of transmitting coil 22. As described hereinabove, control circuitry 20 receives input from sensor 38, which is configured to determine an indication of divergence of (i) the real-time resonance frequency of transmitting coil 22, with respect to (ii) the reference resonance frequency of transmitting coil 22, further described hereinbelow. If a divergence is indicated, then control circuitry 20 utilizes one or more electrical components coupled to control circuitry 20 to reduce the divergence by tuning the resonance frequency of transmitting coil 22 in order to return it to the reference resonance frequency. The tuning of transmitting coil 22 back to the reference resonance frequency is illustrated by arrow 48 in FIG. 2.

For some applications, housing 26 and transmitting coil 22 are flexible, and changes in the inductance and/or capacitance of transmitting coil 22 may be due to transmitting coil 22 flexing (e.g., due to patient movement), such that the real-time resonance frequency of transmitting coil 22 is a flexed resonance frequency of transmitting coil 22. For some applications, changes in inductance and/or capacitance of transmitting coil 22 may be occur due to changes in temperature of transmitting coil 22 or due to transmitting coil 22 being in close proximity to metal in the environment of the patient.

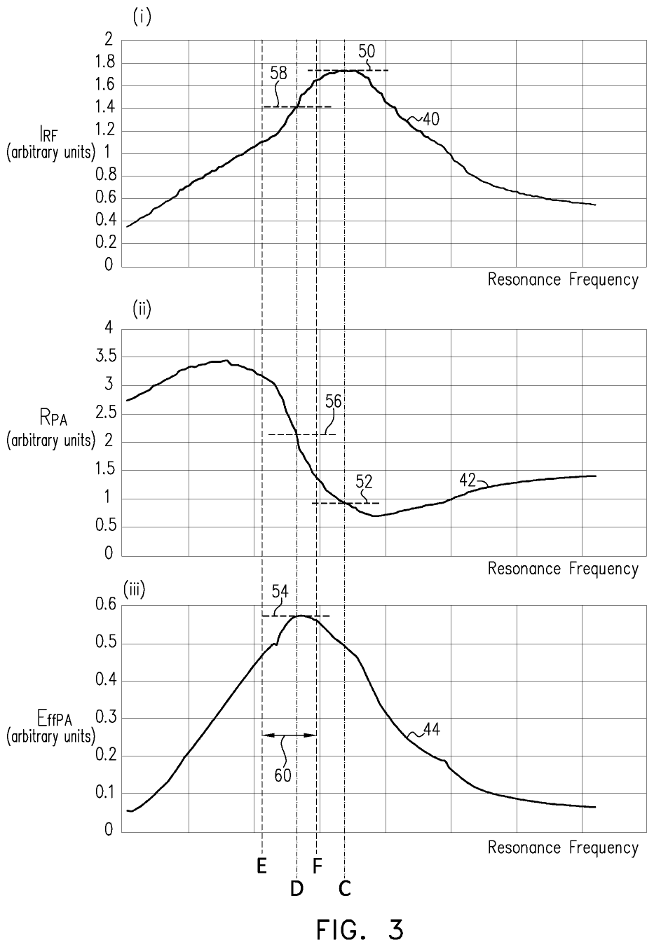

Reference is now made to FIG. 3, which again shows graphs (i), (ii), and (iii) depicting, respectively, the RF current (I_{RF}) at the output of power stage 28, the input resistance (R_{PA}) of power stage 28, and the efficiency of power stage 28, all plotted as functions of the resonance frequency of transmitting coil 22, in accordance with some applications of the present invention. As noted hereinabove, U.S. Pat. No. 7,015,769 to Schulman describes a power sense circuit that monitors the power delivered by a power amplifier to a tuned circuit and a processor that sequentially switches the capacitors in a binary progression format to achieve maximum power delivery indicative of conforming the resonant frequency of the tuned circuit to the reference frequency. However, the inventors have determined that, as shown by vertical line C in FIG. 3, when the RF current (I_{RF}) at the output of power stage 28 is maximized, illustrated by horizontal dashed line 50 on graph (i), the input resistance (R_{PA}) of power stage 28 drops quite low, illustrated by horizontal dashed line 52 on graph (ii). The input voltage (V_{PA}) to power stage 28 is typically kept almost constant and as such, if the input resistance (R_{PA}) drops, the input current (I_{PA}) to power stage 28 will increase. Since control circuitry 20 is battery-operated, a high input current (I_{PA}) to power stage 28, i.e., a high current demand on battery 32, may cause rapid depletion of battery 32 and/or may cause battery 32 to disconnect if the current demand on the battery surpasses a battery overcurrent protection limit for the battery.

Thus, the inventors have realized that in order to increase the life of battery 32 it is advantageous to set the reference resonance frequency of transmitting coil 22 such that when transmitting coil 22 is at the reference resonance frequency the efficiency of power stage 28 is at or near its maximum. For a given power output, when power stage 28 is operating at its maximum efficiency, a minimum power input is required in order to achieve the given power output. Being able to use a minimum power input to power stage 28 for the same power output results in battery 32 operating for a longer duration. As shown by vertical line D on FIG. 3, when efficiency of power stage 28 is at its maximum, illustrated by horizontal dashed line 54 on graph (iii), the input resistance (R_{PA}) of power stage 28 is considerably higher, illustrated by horizontal dashed line 56 on graph (ii). When the input resistance (R_{PA}) of power stage 28 is higher, the input current (I_{PA}) to power stage 28, and thus the amount of current (I_{BAT}) being drawn from battery 32, is lower. Therefore, whereas maintaining the resonance frequency of transmitting coil 22 in a manner that maximizes efficiency of power stage 28 lowers the amount of power transmitted to medical implant 24 (i.e., the RF current (I_{RF}) at the output of power stage 28 is lower, illustrated by horizontal dashed line 58 on graph (i)), it extends the life of battery 32 due to the lower current demand on battery 32.

It is noted that, for some applications, the reference resonance frequency of transmitting coil 22 may be set so that the efficiency of power stage 28 is near maximum or within a certain range of maximum efficiency. This range is typically selected such that the efficiency of power stage 28 does not drop significantly from the maximum efficiency and such that the RF current (I_{RF}) at the output of power stage 28 does not exceed a certain level (in order to avoid being near maximum RF current and thus rapidly depleting the battery or surpassing the battery overcurrent protection limit). Thus, for some applications, the reference resonance frequency of transmitting coil 22 is set such that at the reference resonance frequency of transmitting coil 22 (a) efficiency of power stage 28 (i.e., efficiency of the power delivered from power stage 28 to the variable load) is at least 70% of a maximum efficiency of power stage 28 as a function of the resonance frequency of transmitting coil 22, and (b) the current driven through transmitting coil 22 (i.e., the RF current (I_{RF}) at the output of power stage 28) is less than 96% of a maximum current drivable through transmitting coil 22 as a function of the resonance frequency of transmitting coil 22. This range for the reference resonance frequency of transmitting coil 22 is illustrated in FIG. 3 by double headed arrow 60 between dashed vertical lines E and F.

It is noted that for some applications the real-time resonance frequency of transmitting coil 22 is measured when the device is first activated, under static conditions. For example, for some applications, the specific load configuration of transmitting coil 22 for the reference resonance frequency is found by scanning the different configurations of compensation circuit 36 upon activation of the device under static conditions (i.e., under conditions in which the inductance and capacitance of transmitting coil 22 stays constant) in order to find the optimal efficiency point. Compensation circuit 36 is cycled through various load configurations each resulting in a respective real-time resonance frequency of transmitting coil 22 for which the corresponding efficiency of power stage 28 is determined. By comparing the efficiency of power stage 28 for different load configurations, an optimal load configuration is found for transmitting coil 22 that provides near maximum efficiency of power stage 28 for the given driving frequency. If a change to the load occurs during operation, sensor 38 identifies it and control circuitry 20 uses compensation circuit 36 to restore the load to the best efficiency point by adjusting compensation circuit 36. For some applications, the efficiency of power stage 28 at each load configuration may be determined as follows:
the RF current (I_{RF}) is measured at the output of power stage 28;
the input voltage (V_{PA}) is measured at the input to power stage 28;
the input current (I_{PA}) is measured at the input to power stage 28;
the efficiency of power stage 28 (Eff_{PA}) is defined as:

$${Eff}_{PA} = ( {P}_{out} ) / ( {P}_{in} ) \qquad [ Eqn . 1 ]$$

where P_{OUT} is the power output by power stage 28 and P_{IN} is the power input to power stage 28;
assuming that the resistive part of the load does not vary, P_{OUT} is proportional to the square of I_{RF} (for some applications, a correction for a change in the load resistive part can be also implemented); and
P_{IN} may be calculated from the input voltage (V_{PA}) to power stage 28 and the input current (I_{PA}) to power stage 28 as follows:

$${P}_{IN} = {V}_{PA} * {I}_{PA} \qquad [ Eqn . 2 ]$$

(Alternatively to calculating and using P_{IN} as described throughout the application and recited in the claims, another indication of power may be used, e.g., P_{BAT} (calculated from the voltage (V_{BAT}) and current (I_{BAT}) being drawn from battery 32, i.e., P_{BAT}=V_{BAT}*I_{BAT}) or another indicator of power that relates to the power coming out of the battery (for example, in cases where the current (I_{BAT}) from battery 32 goes through DC/DC converter 34 before entering power stage 28, the power leaving battery 32 is the power input to DC/DC converter 34).)

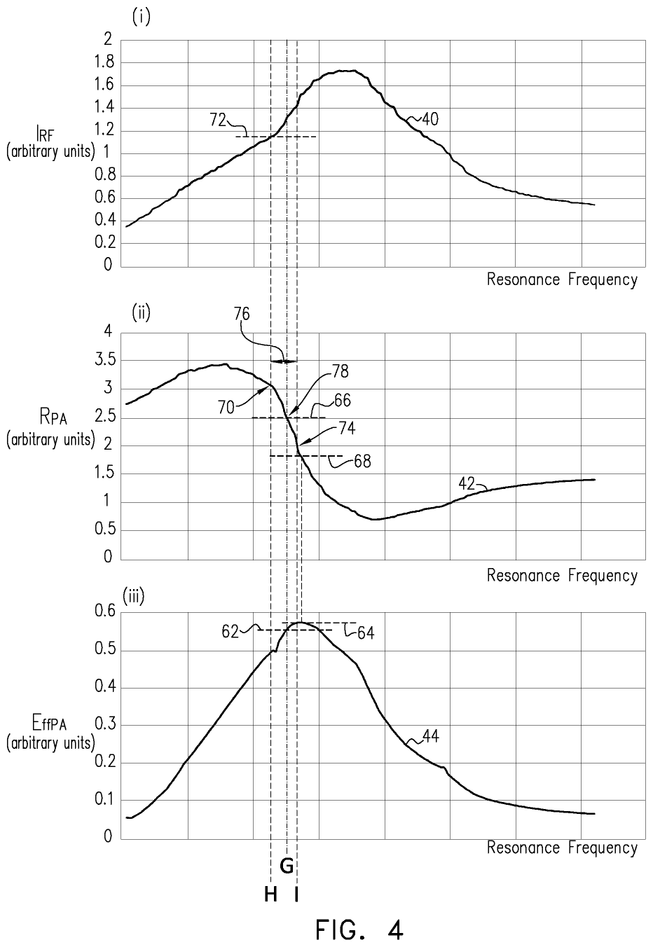

Reference is now made to FIG. 4, which again shows graphs (i), (ii), and (iii) depicting, respectively, the RF current (I_{RF}) at the output of power stage 28, the input resistance (R_{PA}) of power stage 28, and the efficiency of power stage 28, all plotted as functions of the resonance frequency of transmitting coil 22, in accordance with some applications of the present invention. The inventors have further realized that for some applications, even when efficiency of power stage 28 is maximized at the reference resonance frequency of transmitting coil 22 (thus elongating the life of battery 32), dynamic changes of the real-time resonance frequency of transmitting coil 22 starting from the point of maximum efficiency may cause the input resistance (R_{PA}) of power stage 28 during operation to suddenly decrease to a point where the current (I_{BAT}) drawn from battery 32 may pass the battery overcurrent protection limit. As described hereinabove, this is because near the maximum efficiency of power stage 28, curve 42 representing the input resistance (R_{PA}) of power stage 28 has a very steep slope, i.e., at resonance frequencies of transmitting coil 22 that result in maximum or near maximum efficiency of power stage 28 the input resistance (R_{PA}) of power stage 28 changes very quickly in response to small changes in the real-time resonance frequency of transmitting coil 22. For some cases compensation circuit 36 is used to restore the real-time resonance frequency of transmitting coil 22 to the reference resonance frequency. However, in some cases a change in resonance frequency of transmitting coil 22 may occur at a faster rate than compensation circuit 36 is configured to accommodate for. For example, control circuitry 20 may check the resonance frequency of transmitting coil 22, using sensor 38, at a sampling rate that may be as low as 10 Hz, e.g., the sampling rate may be 10-100 Hz, e.g., 10-30 Hz.

Due to curve 44 (efficiency of power stage 28) having a rounded peak, while curve 42 (input resistance (R_{PA}) of power stage 28) has a steep slope over the same range of resonance frequencies, the inventors have realized that it is advantageous to set the reference resonance frequency of transmitting coil 22 to be slightly to the left of the peak of curve 44, as illustrated by vertical line G in FIG. 4, i.e., the reference resonance frequency of transmitting coil 22 is lower than a resonance frequency of transmitting coil 22 at which the efficiency of power stage 28 is the maximum efficiency. As shown, vertical line G intersects curve 44 at an efficiency (horizontal dashed line 62) that is only slightly less than the maximum efficiency (horizontal dashed line 64), while vertical line G intersects curve 42 at an input resistance (R_{PA}) of power stage 28 (horizontal dashed line 66) that is substantially higher than the input resistance (R_{PA}) of power stage 28 would be when the efficiency of power stage 28 is at its maximum (horizontal dashed line 68). Thus, while still staying near maximum efficiency of power stage 28, setting the reference resonance frequency to be slightly to the left of the efficiency peak increases the likelihood that dynamic changes of the real-time resonance frequency that occur during operation nevertheless result in an input resistance (R_{PA}) of power stage 28 that is sufficiently high as to avoid the current (I_{BAT}) drawn from battery 32 surpassing the battery overcurrent protection limit. Therefore, for some applications, the reference resonance frequency of transmitting coil 22 is a resonance frequency of transmitting coil 22 at which the efficiency of power stage 28 is less than 95% of the maximum efficiency.

For some applications, in order to find an optimum input resistance (R_{PA}) of power stage 28 for use in setting the reference resonance frequency of transmitting coil 22, a range for the input resistance (R_{PA}) of power stage 28 is defined based on the expected dynamic load change of the system. This range for the input resistance (R_{PA}) of power stage 28 is illustrated in FIG. 4 by double headed arrow 76 between dashed vertical lines H and I. The range is defined such that over the entire range (i) enough power is transmitted for medical implant 24 to operate, (ii) efficiency of power stage 28 remains near maximum efficiency, and (iii) the current (I_{BAT}) drawn from battery 32 does not pass the battery overcurrent protection limit. For some applications, an upper limit (R_{PA}-max) of this range (illustrated by arrow 70) is set such that the RF current (I_{RF}) does not drop below a threshold level (horizontal dashed line 72) in order to ensure that enough power is transmitted for medical implant 24 to operate. For some applications the lower limit (R_{PA}-min) of this range (illustrated by arrow 74) is set by the battery overcurrent protection limit, i.e., the lower limit (R_{PA}-min) is set such that the current (I_{BAT}) drawn from battery 32 stays below the battery overcurrent protection limit. The optimum (R_{PA}) of power stage 28 for use in setting the reference resonance frequency of transmitting coil 22 is within this range, e.g., at the average of the R_{PA}-max and the R_{PA}-min (illustrated by arrow 78).

Thus, for some applications, control circuitry 20 is configured such that the reference resonance frequency of transmitting coil 20 is a resonance frequency of transmitting coil 22 at which the efficiency of power stage 28 is (a) less than 95% of the maximum efficiency of power stage 28 as a function of the resonance frequency of transmitting coil 22 (so as to avoid surpassing the battery overcurrent protection limit), and (b) at least 75%, e.g., at least 80% of the maximum efficiency of power stage 28 as a function of the resonance frequency of transmitting coil 22 (so as to ensure enough power to operate medical implant 24). For some applications, control circuitry 20 is configured such that the reference resonance frequency of transmitting coil 20 is a resonance frequency of transmitting coil 22 at which the current driven through transmitting coil 22 (i.e., RF current (I_{RF}) at the output of power stage 28) is at least 10% greater than a minimum current that is required to drive medical implant 24.

For some applications, upon activation of the control circuitry 20, the compensation circuit is scanned to first find the specific load configuration, i.e., the specific resonance frequency of transmitting coil 22 that results in the maximum efficiency of power stage 28 (as described hereinabove). Subsequently, over a range of resonance frequencies that is to the left of the peak of curve 44, the input resistance (R_{PA}) of power stage 28 is scanned in order to find R_{PA}-max and R_{PA}-min for the system (as described hereinabove). The input resistance (R_{PA}) of power stage 28 is scanned by measuring the respective input voltages (V_{PA}) and input currents (I_{PA}) at the input to power stage 28 over the range of resonance frequencies. Once the R_{PA}-max and R_{PA}-min are found, the optimum input resistance (R_{PA}) of power stage 28 is selected between R_{PA}-max and R_{PA}-min, e.g., the average of R_{PA}-max and R_{PA}-min. The resonance frequency of transmitting coil 22 that results in the optimum input resistance (R_{PA}) of power stage 28 is set as the reference resonance frequency of transmitting coil 22.

For some applications, sensor 38 includes a phase detector, such as the phase detector disclosed in the above-referenced U.S. Pat. No. 11,213,685 to Oron et al. For example, the phase difference between the modulation driving power stage 28 and the RF current (I_{RF}) may be detected at the reference resonance frequency of transmitting coil 22. As the load changes, i.e., as the resonance frequency of transmitting coil 22 changes, the phase of the RF current (I_{RF}) changes. Thus, the phase detector may then be used to determine the indication of the divergence of the real-time resonance frequency of transmitting coil 22 with respect to the reference resonance frequency of transmitting coil 22.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1-10. (canceled)

11. Apparatus for use with a medical implant that comprises a receiving coil, the apparatus comprising:
a housing configured to be placed against skin of a subject;
a transmitting coil disposed in the housing;
control circuitry comprising a power stage and configured to transmit power to the medical implant by activating the power stage to drive a current at a fixed frequency through the transmitting coil to induce an induced current in the receiving coil;
a battery coupled to the housing and configured to power the control circuitry;
a sensor configured to determine an indication of divergence of
(i) a real-time resonance frequency of the transmitting coil, with respect to
(ii) a reference resonance frequency of the transmitting coil; and
one or more electrical components, coupled to the control circuitry,
wherein:
the control circuitry is configured to receive an input from the sensor indicative of the divergence and use the one or more electrical components to reduce the divergence by tuning the resonance frequency of the transmitting coil in response to the determination of the sensor.

12. The apparatus according to claim 11, wherein the control circuitry is configured such that the reference resonance frequency of the transmitting coil is a resonance frequency of the transmitting coil that optimizes efficiency of the power stage with respect to the fixed frequency.

13. The apparatus according to claim 11, wherein the control circuitry is configured such that the reference resonance frequency of the transmitting coil is a resonance frequency of the transmitting coil that optimizes RF current at the output of the power stage with respect to the fixed frequency.

14. The apparatus according to claim 11, wherein the control circuitry is configured such that the reference resonance frequency of the transmitting coil is a resonance frequency of the transmitting coil that optimizes input resistance of the power stage with respect to the fixed frequency.

15. The apparatus according to claim 11, wherein the control circuitry is configured such that the reference resonance frequency of the transmitting coil is a resonance frequency of the transmitting coil at which efficiency of the power stage is less than a maximum efficiency of the power stage as a function of the resonance frequency of the transmitting coil, the efficiency of the power stage defined as power output by the power stage divided by power input to the power stage.

16. The apparatus according to claim 15, wherein the control circuitry is configured such that the reference resonance frequency of the transmitting coil is a resonance frequency of the transmitting coil at which the efficiency of the power stage is at least 70% of the maximum efficiency.

17. The apparatus according to claim 15, wherein the control circuitry is configured such that the reference resonance frequency of the transmitting coil is a resonance frequency of the transmitting coil at which the efficiency of the power stage is less than 95% of the maximum efficiency.

18. The apparatus according to claim 17, wherein the control circuitry is configured such that the reference resonance frequency of the transmitting coil is a resonance frequency of the transmitting coil at which the efficiency of the power stage is at least 75% of the maximum efficiency.

19. The apparatus according to claim 11, wherein the control circuitry is configured such that the reference resonance frequency of the transmitting coil is a resonance frequency of the transmitting coil at which the current driven through the transmitting coil is less than a maximum current drivable through the transmitting coil as a function of the resonance frequency of the transmitting coil.

20. The apparatus according to claim 19, wherein the control circuitry is configured such that the reference resonance frequency of the transmitting coil is a resonance frequency of the transmitting coil at which the current driven through the transmitting coil is less than 96% of the maximum current.

21. The apparatus according to claim 11, wherein the control circuitry is configured such that the reference resonance frequency of the transmitting coil is a resonance frequency of the transmitting coil at which:
(a) efficiency of the power stage is less than a maximum efficiency of the power stage as a function of the resonance frequency of the transmitting coil, the efficiency of the power stage defined as power output by the power stage divided by power input to the power stage, and
(b) the current driven through the transmitting coil is less than a maximum current drivable through the transmitting coil as a function of the resonance frequency of the transmitting coil.

22. The apparatus according to claim 11, wherein the housing is a flexible housing.

23. The apparatus according to claim 11, wherein the transmitting coil is a flexible transmitting coil and wherein the real-time resonance frequency is a flexed resonance frequency when the transmitting coil is flexed.

24. The apparatus according to claim 11, wherein the control circuitry is configured to transmit power to the medical implant by activating the power stage to drive the current at a fixed frequency of 6.78 MHz through the transmitting coil to induce the induced current in the receiving coil.
